(19) United States
(12) Patent Application Publication
(10) Pub. No.: US 2017/0362453 A1
(43) Pub. Date: Dec. 21, 2017

(54) CARBON BLACK PIGMENT FOR IMPROVED DURABILITY

(71) Applicant: E I DU PONT DE NEMOURS AND COMPANY, Wilmington, DE (US)

(72) Inventors: Waifong Liew Anton, Wilmington, DE (US); Michael Stephen Wolfe, Wilmington, DE (US); Anthony W. Kluth, Villanova, PA (US)

(21) Appl. No.: 15/532,345

(22) PCT Filed: Dec. 8, 2015
(86) PCT No.: PCT/US15/64463

§ 371 Date: Jun. 1, 2017

Related U.S. Application Data
(60) Provisional application No. 62/094,127, filed on Dec. 19, 2014.

(51) Int. Cl. C09D 11/326; C09D 11/102

(52) U.S. Cl. CPC C09D 11/326; C09D 11/102

(57) ABSTRACT

The present disclosure provides an ink for inkjet printing. The inkjet ink comprises a carbon black pigment dispersion. The carbon black pigment in the dispersion has low oil absorption.

### CROSS REFERENCE TO RELATED APPLICATIONS

This application claims priority under 35 U.S.C. §119 from U.S. Provisional Application Ser. No. 62/094,127, filed Dec. 19, 2014, which is incorporated by reference in its entirety.

### BACKGROUND OF THE DISCLOSURE

This disclosure pertains to an aqueous inkjet ink, in particular to an aqueous inkjet ink comprising a carbon black pigment dispersion where the pigment in the dispersion has low oil absorption.

Inkjet printing is a non-impact printing process in which droplets of ink are deposited on a substrate, such as paper, to form the desired image. Inkjet printers are equipped with an ink set which, for full color printing, typically comprises a cyan, magenta and yellow ink (CMY). An ink set also commonly comprises a black ink (CMYK) with the black ink being the most common color.

To improve print durability, it is common to add a large quantity of hinder to an ink. However, the presence of large quantity of binder also increases the dry time, and cause other problems such as reduction of OD, higher viscosities, poor ink stability, etc.

Fast on set of durability is important for inkjet printing, it is often necessary for the recently printed-article to come into contact with the paper-handling mechanism of the printer, e.g., in the case of duplex printing where both sides of the media are printed. In this case the first printed side may not yet be completely dry and as a result the print surface can be damaged and the ink can transfer onto the paper-handling mechanism and then onto subsequent prints. This problem is particularly acute when using a web-press which involves considerable paper-handling at high speeds. Often the press uses heated rollers to transfer media which is prone to having problems as the drying ink sticks to the rollers. Severe problems may be encountered when slow-drying inks are printed onto non- or poor-absorbent media such as coated offset media.

A need still exists for inkjet ink that provides rapid onset of durability. The present disclosure satisfies this need by providing ink compositions containing carbon black pigment dispersion with the pigment having low oil absorption.

### SUMMARY OF THE DISCLOSURE

An embodiment provides an ink comprising a pigment dispersion wherein said pigment dispersion comprises a carbon black pigment and an aqueous vehicle, wherein said pigment has an oil absorption of between about 110 to about 50.

Another embodiment provides that the oil absorption is between about 95 to about 50.

Another embodiment provides that is printed on a low porosity media.

Another embodiment provides that pigment s dispersed by a polymeric dispersant.

Another embodiment provides that polymeric dispersant is a polyurethane.

Another embodiment provides that the ink further comprising a polymeric binder.

Another embodiment provides that ratio of said pigment to the total of said polymeric dispersant and said polymeric binder is at least about 7:1.

Another embodiment provides that pigment is a self-dispersing pigment.

Yet another embodiment provides that when the pigment is a self-dispersing pigment containing a polymeric binder, the ratio of the pigment to the polymeric binder is about of 7:1.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “OD” means optical density.

As used herein, the term “degree of functionalization” refers to the amount of hydrophilic groups present on the surface of the SDP per unit surface area, measured in accordance with the method described further herein.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

The materials, methods, and examples herein are illustrative only except as explicitly stated, and are not intended to be limiting.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present disclosure may contain about 60% to about 95% water, based on the total weight of the aqueous vehicle.

The amount of aqueous vehicle in the ink is typically in the range of about 70% to about 99.8%; specifically about 80% to about 99.8%, based on total weight of the ink. The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series from Air Products), ethoxylated primary (e.g., Neodol® series from Shell) and secondary (e.g., Tergitol® series from Union Carbide) alcohols, sulfosuccinates (e.g., Aerosol® series from Cytec), organosilicones (e.g., Silwet® series from Witco) and fluoro surfactants (e.g., Zonyl® series from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of from about 0.01% to about 5%, and specifically from about 0.2% to about 2%; based on the total weight of the ink.

### Pigments

The term “pigment” as used herein means an insoluble colorant that requires to he dispersed with a dispersant and processed under dispersive conditions in the presence of a dispersant. The dispersion process results in a stable dispersed pigment.

The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698. A typical pigment of the present disclosure is carbon black.

The pigment of the present disclosure can also be a self-dispersing self-dispersible) pigment. The term self-dispersing pigment refers to pigment particles whose surface has been chemically modified with hydrophilic, dispersability-imparting groups that allow the pigment to be stably dispersed in an aqueous vehicle without a separate dispersant. “Stably dispersed” means that the pigment is finely divided, uniformly distributed and resistant to particle growth and flocculation.

The self-dispersing pigment dispersion comprises water, a pigment, typically a carbon black pigment, having an oxidized surface and optionally additives. To oxidize the surface of the pigment, the following methods can be used:

(a) an oxidation method using contact with air;

(b) a gas phase oxidation method using reaction with a nitrogen oxide or ozone; and

(c) a liquid phase oxidation method using an oxidizing agent such as nitric acid, potassium permanganate, potassium dichromate, chlorous acid, perchloric acid, a hypohalite, hydrogen peroxide, a bromine aqueous solution or an ozone aqueous solution; etc. The surface may also he modified through plasma treatment or the like.

In one embodiment, the process utilized for preparing the self-dispersing pigment is by oxidizing the pigment with ozone in an aqueous environment, typically de-ionized water, while simultaneously subjecting the pigment to at least one dispersive mixing operation. This process is described in U.S. Pat. No. 6,852,156. Oxidation is carried out until the surface of the pigment is found to have an oil adsorption of at least about 155 to about 179 mL/100 g, and an acid content of at least about 0.98 microequivalent/m2. The length of time needed for the oxidation step to obtain a pigment with the desired properties is dependant on the type of equipment used and the process used for oxidizing the pigment. The length of time needed to obtain the desired amount of acid moieties can be determined by taking samples at time intervals and titrating for the acid content per the procedure described herein. In this oxidation process, an ozone generator generates ozone from compressed oxygen or air fed into a feed tank and delivers the ozone to a pre-mix tank. Water and pigment are also delivered to the pre-mix tank via water supply and pigment supply. The order in which the pigment, water, and ozone are introduced into the pre-mix tank is not particularly important, so long as the water is added before the ozone.

The reactants are agitated in the pre-mix tank via a high speed disperser. The pre-mix tank has a vent to atmosphere with an ozone destruction device. To aid with the agitation and increase the process efficiency it is generally preferred to introduce the ozone in a manner that produces more and smaller bubbles as opposed to fewer and larger bubbles.

Physical property and composition of pigments are important factors to attain a high quality performance of ink jet inks and coatings. In the present disclosure, the types of pigments to be used are not particularly limited in the properties of primary particle size and surface area. For the ink jet ink application, it is typical to use pigments having a primary particle size of less than 30 nm. Surface area measured by BET method affects significantly the operating conditions to attain self-dispersing pigments. The higher the pigment surface area is, the longer the cycle time is usually needed.

As noted above, it is typical or required, depending on the embodiment, to subject the mixture of water, ozone and pigment to at least one dispersive mixing step. Most of mixing or stirring applications involve pumping and mass flow of liquid, liquid-solid, or liquid-gas. The intensity of mixing can be characterized by the energy input or the effective shear rate. The effective shear rate for mixing usually ranges from 50 to 200 sec⁻¹ (James Y. Oldshue, “Fluid Mixing Technology,” p. 29, 1983) and from 200 to 20,000 sec⁻¹ for dispersive mixing or dispersion (Temple C. Patton, “Paint Flow and Pigment Dispersion,” p. 356, 1979). Accordingly, the term “dispersive mixing” is used herein to identify a mixing operation that provides an effective shear rate of at least 200 sec⁻¹. Such well known devices as a media mill, attritor, hammer mill, Microfluidizer® (commercially available from Microfluidics Corp), homogenizer, jet mill, fluid mill and similar high energy dispersing devices can be used to advantage in the present disclosure.

The reactants are transferred via a pump from the pre-mix tank into a dispersive mixing apparatus. The type of device used for the dispersive mixing step will depend, to some extent, on the type of pigment being oxidized and all the characteristics of the pigment, in general, color pigments need higher energy mixing as compared to the carbon black pigments. The preceding statement is not meant to imply that the process will not work unless the proper mixing device is selected, but rather to note that more than one dispersive mixing step may be needed if the selected device lacks sufficient energy. In general, it has been found that media milling and passing through a plurality of nozzles within a liquid jet interaction chamber at a liquid pressure of at least 1000 psi, i.e., such as would occur in a Microfluidizer®, work well in the process and are most typical.

After the oxidation and dispersive mixing step, the pigment mixture is typically purified. In the purification procedure, salts are removed from the pigment mixture (referred to herein as “desalination”) and the mixture is filtered. The desalination process is typically performed by ultrafiltration.

The concentration of pigment that can be used in the process is not particularly critical and is more a function of the type of pigment and the type of equipment used in the process than it is a limitation on the process itself. Generally speaking, however, the maximum amount of pigment should not exceed 50 wt %. A pigment concentration of 5-20 wt %, especially about 10 wt %, is preferred for process efficiency.

While not to be bound to theory, it is believed that pigments with low oil absorption have less structure which translates to faster release of solvents and solvents/water to the atmosphere by evaporation, or by permeating to the print media.

### Oil Absorption Measurement

DBP oil absorption is the amount of oil absorption using dibutyl phthalate, typically, as described in ASTM D3493. The carbon black pigment of the present disclosure are available commercially or can he readily prepared by one having ordinary skill in the art following the procedures described above under Pigment.

### Polymeric Dispersant

The polymeric dispersant for the non-self-dispersing pigment(s) may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “random polymer” also includes polyurethanes. The “structured polymer” means polymers having a block, branched, graft or star structure. Examples of structured polymers include AB or

BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can he used are described, for example, in U.S. Pat. No. 6,117,921, U.S. Pat. No. 6,262,152, U.S. Pat. No. 6,306,994 and U.S. Pat. No. 6,433,117.

### Polymeric Binder

The ink of the present disclosure can contain polymeric binder. Typically the polymeric binder is a polyurethane such as the ones described in publication WO 2009/143418. The binder of the present disclosure also include the cross-linked polyurethane binders disclosed in U.S. Patent Application Publication No. 20050182154, which is incorporated by reference herein as if fully set forth, under the section entitled “Polyurethane Dispersoid Binders (PUDs)”. Typically a binder is different from the polyurethane dispersant described above and non-reactive to the colorant. The binder is typically added to an ink during the final formulation stage, not during the preparation of a pigment dispersion.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 3% and more typically in amounts up to 1% by weight, based on the total weight of the ink.

Inclusion of sequestering (or chelating) agents such as ethylenediaminetetraacetic acid, iminodiacetic acid, ethylenediamine-di(o-hydroxyphenylacetic acid), nitrilotriacetic acid, dihydroxyethylglycine, trans-1,2-cyclohexanediaminetetraacetic acid, diethylenetriamine-N,N,N′,N″,N″-pentaacetic acid, and glycoletherdiamine-N,N,N′,N′-tetraacetic acid, and salts thereof, may be advantageous, for example, to eliminate deleterious effects of heavy metal impurities.

Polymers may be added to the ink to improve durability or other properties. The polymers can he soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 10% by weight, based on the total weight of an ink. The upper limit is dictated by ink viscosity or other physical limitations.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 45° C. Viscosity can be as high as 30 cP at 25° C., but is typically much lower, more typically less than 10 cP. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

### Substrate

The inks of the present disclosure can be printed on common print substrate such as paper and textile. The inks of the present disclosure is most advantageous for printing on low porosity media. Such low porosity media includes offset paper, coated paper, digital papers for toner-based digital printing, etc.

Offset paper and coated paper are generally known to have poor receptivity to aqueous ink jet inks. These papers have low surface porosity due to calendaring and/or application of one or more layers of hydrophobic coating layers. Such surface smoothing procedures and coatings provide papers that can withstand the high tack of traditional printing paste and/or be receptive to hydrophobic toner particles. In this category of substrates, testing was done on HP Color Laser Glossy Brochure Paper Q661IA (Hewlett Packard, Calif.), a substrate marketed for use with laser printers; and OK Topcoat Plus, an offset paper (Oji Co., Japan).

The substrates tested include Hammermill Copy Plus paper and Xerox Business 4200 paper without ColorLok® treatment, both of which are plain uncoated porous papers. Another paper used was HP Multipurpose Paper which is an uncoated porous paper, but with HP ColorLok® pre-treatment for better interactions with water-based inkjet inks. Also used was HP Inkjet Glossy Brochure Paper Q1987A which is coated on both sides to be receptive to water-base ink jet inks.

### EXAMPLES

The invention is further illustrated by, but not limited to, the following examples, in which parts and percentages are by weight unless otherwise noted.

### Self-Dispersing Carbon Black Pigment Dispersions

A series of self-dispersing pigment dispersions were prepared using NIPex®, Arosperse, Printex® and Special Black pigments from Orion Engineering Carbons (Frankfurt a. M., Germany), Monarch® from Cabot Corporation (Boston, Mass.), and Raven® pigment from Birla Carbons (Bahia, Brazil). The oil absorption of these self-dispersing pigment dispersions are listed in Table 1 below.

TABLE 1

| Pigment | | Oil Absorption |
|---|---|---|
| Dispersion | Pigment Grade | (mL/100 g) |
| A | Printex ® 85 | 54 |
| B | Raven ® 2500 Ultra | 67 |
| C | Arosperse 19 | 90 |
| D | Raven ® 3500 | 105 |
| E | Monarch ® 1000 | 110 |
| F | Special Black 4 | 110 |
| G | Monarch ® 880 | 112 |
| H | Printex ® U | 115 |
| I | NIPex ® 150 | 120 |
| J | Monarch ® 700 | 122 |
| K | NIPex ® 160 | 128 |
| L | NIPex ® 180 | 140-160 |

### Polymer Binder A

Polymer Binder A is a polyurethane with a composition of IPDI/T650/DMPA, and an acid number of 45 grams of KOH per 100 g of polymer solid. It was prepared according to the same procedure described for the preparation of the Example 7 polyurethane in publication WO 2009/143418, the disclosures of which are incorporated by reference herein for all purposes as if fully set forth.

### Evaluation of Pigment Dispersions A-L

Inks were prepared by combining Pigment Dispersions A-L at a concentration of 3% of pigment solids in the final ink with 0-2% of polyurethane Binder A, about 20% of common organic solvents such as pyrrolidone, about 0.3% of common aqueous-compatible surfactant, about 0.2% biocide, and water to complete the remaining balance to 100%.

The inks were printed using a HP Deskjet 6940 printer equipped with a duplexer unit. After printing, the images were left to dry for an hour at ambient conditions before subjecting to highlighter durability tests using Faber-Castell Textliner 48 with a weight of 125 g (HL1) and 1 kg (HL2) applied to the highlighter tip. The degree of color transfer to the unprinted areas was observed and given a rating on a scale of 0 to 5, where a rating of 0 indicate complete/near complete transfer of the printed image over to the unprinted areas and a rating of 5 indicate no transfer of the printed image over to the unprinted areas. For each of the applied force, highlighting was applied one time, and also two times over the same image. The average ratings under different number of times the images were highlighted are reported.

After printing, the images were left to thy for an hour at ambient conditions before subjecting to scratch durability tests conducted by dragging a polystyrene stylus over the printed images, with 500 g of weight applied to the stylus. The remaining optical density of the scratched area as a percentage of the untouched image is an indication of the durability towards scratching.

Durability toward duplexing was conducted by selecting double-side printing and varying the hold time in the selection menu, from the minimum (about 3 seconds) to the maximum (about 28 seconds). The selection of double-side printing causes the paper to be re-introduced through the paper-handling mechanisms of the printer so that the second side can be printed. This exposes the images on the first side to potential scratching and smearing by physical contacts with the paper-handling mechanisms. The shorter the hold time, the potentially wetter state of the prints on the first side will be during this encounter. The longer the hold time, the drier the images and potentially more durable the images on the first printed side would be. However, longer hold time causes slower printing through-put of final printed pages.

The performance results for printing on plain paper are summarized in Table 2 below. These results show that when printed on plain papers, pigments with lower oil absorption give moderately higher ratings (better durability) than higher oil absorption pigments. The addition of polymer binder A improves durability rating over inks without binder A.

TABLE 2

| | | | | | | | | Hewlett | |
|---|---|---|---|---|---|---|---|---|---|
| | | | | | | Xerox | | Packard | |
| | | Oil | | Hammermill | | Business | | HP | |
| | | Absorption | | Copy Plus | | 4200 Paper | | Multipurpose | |
| Ink | Dispersion | (mL/100 g) | Binder | HL1 | HL2 | HL1 | HL2 | HL1 | HL2 |
| 1 | A | 54 | none | 4.75 | 3.25 | 5 | 3.5 | 4.5 | 2.5 |
| 1A | A | 54 | 2% A | 4.75 | 3 | 5 | 3.5 | 4.75 | 2.5 |
| 2 | B | 67 | none | — | — | — | — | 3.5 | 2.25 |
| 2A | B | 67 | 2% A | — | — | — | — | 4 | 2 |
| 3 | L & A, | est. 76 | none | 4.75 | 3 | 5 | 3.75 | 4.75 | 2.25 |
| | 1:3 | | | | | | | | |
| 3A | C | 90 | 2% A | — | 3.5 | — | 3.5 | 4.5 | 2.75 |
| 4 | C | 90 | none | — | 3.5 | — | 3.75 | 4.5 | 2.25 |
| 5 | L & A, | est. 97 | none | 4.75 | 2.75 | 4.75 | 3.5 | 4.5 | 2 |
| | 1:1 | | | | | | | | |
| 6 | D | 105 | none | 4.75 | 3 | 4.75 | 3 | 4.5 | 2 |
| 6A | D | 105 | 2% A | 4.75 | 3.5 | 4.75 | 3.75 | 4.5 | 2.25 |
| 7 | E | 110 | none | — | — | 4.75 | 3.25 | 3.75 | 2 |
| 8 | F | 110 | none | 4.25 | 2.25 | 4.75 | 2 | 4.25 | 1.5 |
| 9 | G | 112 | none | — | — | — | — | 3 | 1.75 |
| 9A | G | 112 | 2% A | 4.75 | 2.75 | 4.5 | 3 | 4.5 | 2.5 |
| 10 | H | 115 | none | 4.5 | 2.5 | 4.5 | 2.5 | 3.75 | 2 |
| 11 | I | 120 | none | 4.25 | 2.5 | 4.5 | 2.25 | 3.75 | 2 |
| 12 | J | 122 | none | — | — | — | — | 3.5 | 2 |
| 13 | K | 128 | none | 4 | 2.5 | 4.5 | 2.25 | 3.5 | 1.5 |
| 13A | K | 128 | 2% A | 4.75 | 2.5 | 5 | 2.75 | 4 | 1.75 |
| 14 | L | 140-160 | none | 4.25 | 2 | 4.5 | 2.5 | 3.75 | 1.75 |

The performance results for printing on a brochure paper treated with inkjet receptive coatings, HP Inkjet Glossy Brochure Paper (Q1987A), are summarized in Table 3 below. These results showed that when printed on ink-jet receptive brochure paper, pigments with lower oil absorption also gave higher ratings (better durability) than higher oil absorption pigments.

TABLE 3

| | | | | | OD Loss, | Duplex, | Duplex, |
|---|---|---|---|---|---|---|---|
| Ink | Dispersion | HL1 | HL2 | Rub | Scratch | After 28 s | After 3 s |
| 1 | A | 2.75 | 0.5 | 2.5 | −32% | 5 | 4.5 |
| 2 | B | 2.25 | 0.75 | 2 | −35% | 5 | 4.5 |
| 3 | C | — | 0.75 | 1.75 | −25% | 5 | 4.5 |
| 5 | E | 1.5 | 0.25 | 1.75 | −35% | 5 | 4.5 |
| 6 | F | 1.5 | 0.25 | 2.25 | −38% | 5 | 4.5 |
| 12 | J | 1.5 | 0 | 1.75 | −36% | 5 | 4.5 |
| 14 | L | 0.75 | 0.25 | 1.15 | −49% | 3.5 | 3 |

The performance results for printing on an offset-like coated (non-inkjet-receptive) brochure paper. HP Color Laser Glossy Brochure Paper (Q661A), are summarized in Table 4 below. These results showed that when printed on non-ink-jet receptive brochure paper, pigments with lower oil absorption gave significantly higher ratings (better durability) than pigments with higher oil absorption. Addition of polymer Binder A was detrimental to durability for higher oil absorption pigments. In contrast, the durability of lower oil absorption pigments was not negatively impacted by the presence of Binder A.

TABLE 4

| | Dis- | | | | | | |
|---|---|---|---|---|---|---|---|
| | per- | | | | Duplex, | Duplex, | Duplex, |
| Ink | sion | Binder | HL1 | Rub | After 28 s | After 10 s | After 3 s |
| 1 | A | none | 2 | 1.5 | 4.5 | 4.5 | 4 |
| 1A | A | 2% | 2.5 | 1.5 | 4.5 | 4.5 | 4.5 |
| 2 | B | none | — | 1 | 4 | 3.5 | 3.5 |
| 2A | B | 2% | — | 1.5 | 4 | 4 | 3.5 |
| 3 | C | none | — | 1 | 3 | 2.5 | 2 |
| 3A | C | 2% | — | 1.25 | 3.5 | 3 | 2 |
| 4 | D | none | 0.25 | 1.25 | 3.5 | 3.5 | 3 |
| 4A | D | 2% | 0.25 | 0.75 | 2.5 | 2.5 | 2 |
| 5 | E | none | — | 1.25 | 4 | 3.5 | 2.5 |
| 7 | F | none | — | 1 | 3.5 | 2.5 | 2 |
| 13 | K | none | 0.25 | 0 | 3.75 | 3.25 | 2.25 |
| 13A | K | 2% | 0 | 0 | 2.25 | 2 | 1.25 |
| 14 | L | none | 0.25 | 0.5 | 2.75 | 2.5 | 1.25 |

### Polymeric Dispersants

Polymeric dispersants are prepared according to methods described in U.S. Patent Application Publication No. 2012/0214939, which is incorporated by reference herein for all purposes as if fully set forth.

Additional dispersants can be prepared using cyclic amines as terminating amines. An example is provided below using morpholine as a terminating amine.

To a dry, alkali- and acid-free flask equipped with an additional funnel, a condenser and a stirrer, under a nitrogen atmosphere was added Terathane® 650 (300 g), DMPA (180 g), Sulfolane (876 g) and DBTL (0.12 g). The resulting mixture was heated to 60° C. and thoroughly mixed. To this mixture was added IDPI (438 g) via the additional funnel mounted on the flask followed by rinsing any residual IDPI in the additional funnel into the flask with Sulfolane (15 g). The temperature for the reaction mixture was raised to 85° C. and maintained at 85° C. until the isocyanate content reached 0.8% or below. The temperature was then cooled to 60° C. and maintained at 60° C. while Morpholine (30 g) was added via the additional funnel over a period of 5 minutes followed by rinsing the residual Morpholine in the additional funnel into the flask with Sulfolane (5 g). After holding the temperature for 1 hr at 60° C., aqueous KOH (1755 g, 3% by weight) was added over a period of 10 minutes via the additional funnel followed by de-ionized water (207 g). The mixture was maintained at 60° C. for 1 hr and cooled to room temperature to provide a polyurethane dispersant with 25% of solids.

### Preparation of Pigmented Dispersions

The following procedure was used to prepare pigmented dispersions with the polyurethane dispersants described above. Using an Eiger Minimill, a premix was prepared at typically 20-30% pigment loading and the targeted dispersant level was selected at a pigment/dispersant (P/D) ratio of 1.5-3.0. A P/D of 2.5 corresponds to a 40% dispersant level on pigment. Optionally, a co-solvent was added at 10% of the total dispersion formulation to facilitate pigment wetting and dissolution of dispersant in the premix stage and ease of grinding during milling stage. Although other similar co-solvents are suitable, triethylene glycol monobutyl ether (TEB as supplied from Dow Chemical) was the co-solvent of choice. The polyurethane dispersants were pre-neutralized with either KOH or amine to facilitate solubility and dissolution into water. During the premix stage, the pigment level was maintained at typically 27%, and was subsequently reduced to about 24% during the milling stage by the addition of de-ionized water for optimal media mill grinding conditions. After completion of the milling stage, which was typically 4 hours, the remaining letdown of de-ionized water was added and thoroughly mixed.

All the pigmented dispersions processed with co-solvent were purified using an ultrafiltration process to remove co-solvent(s) and filter out other impurities that may be present. After completion, the pigment levels in the dispersions were reduced to about 10 to 15%.

### Preparation of Cross-Linked Pigment Dispersion

In the cross-linking step, a cross-linking compound was mixed with a pigmented dispersion prepared above, and heated between 60° C. and 80° C. with efficient stirring for between 6 to 8 hours. After the cross-linking reaction was completed, the pH was adjusted to at least about 8.0 if needed. Pigment Dispersions M-Q listed in Table 5 below were thus obtained.

TABLE 5

| Pigment | | Oil Absorption |
|---|---|---|
| Dispersion | Pigment | (mL/100 g) |
| M | Arosperse 19 | 90 |
| N | Printex U | 115 |
| O | Monarch ® 700 | 122 |
| P | NIPex ® 160 | 128 |
| Q | NIPex ® 180 | 140 |

### Polymer Binder B

The Polyurethane Dispersoid 1 (PUD EX1), a cross-linked polyurethane, described in U.S. Patent Application Publication No. 20050182154 was employed as Binder B.

### Evaluation of Pigment Dispersions M-Q

Inks were prepared by combining Pigment Dispersions M-Q at 5% of pigment solids in the final ink and 0-5% polyurethane Binder B, with about 25% common organic solvents such as ethylene glycol and pyrrolidone, and about 1% of common aqueous-compatible surfactant, and about 0.2% biocide and water to complete remaining balance to 100%.

The inks were applied to OK Topcoat Plus (Oji Co., Japan) by draw-down of 0.11 of ink with #3 wire-wound rod (Paul N. Garnder, Inc., Pompano Beach, Fla.). The films were dried in an oven set at 95° C. for 2 minutes and tested for durability using an AATCC Crockmeter (Research Triangle Park, N.C.). The ink film was rubbed path with another sheet of unprinted substrate for ten back-and-forth cycles at a pre-set 4 inch path. The durability of the colored film was evaluated for extent of damage to the crocked section in the colored film.

Results of printing of inks containing Pigment Dispersions M-Q on offset paper are summarized in Table 6. The results showed that the pigments with low oil absorption delivered the best durability even without the need for any polymer binder. Also, pigments with lower oil absorption pigment delivered better durability at higher pigment content, perhaps due to forming a thicker dried layer. The presence of polymer binder played a bigger role at image durability as the oil absorption of the pigment increases. Higher oil absorption pigments delivered poor durability without the presence of polymer binders.

TABLE 6

| | | Oil | Amount of | Amount of | Damage to |
|---|---|---|---|---|---|
| | | Absoprtion | Pigment | Binder | Crocked |
| Ink | Dispersion | (mL/100 g) | (%) | (%) | Image |
| 15 | M | 90 | 5% | None | Very Slight |
| 16 | M | 90 | 8% | None | Very Slight |
| 15B | M | 90 | 5% | 5% B | Very Slight |
| 17 | N | 115 | 5% | None | Significant |
| 18 | N | 115 | 8% | None | Slight |
| 17B | N | 67 | 5% | 5% B | Very Slight |
| 19 | O | 122 | 5% | None | Significant |
| 20 | O | 122 | 8% | None | Significant |
| 19B | O | 122 | 5% | 5% B | Very Slight |
| 21 | P | 128 | 5% | None | Significant |
| 22 | P | 128 | 8% | None | Significant |
| 21B | P | 128 | 5% | 5% B | Very Slight |
| 23 | Q | 140-160 | 5% | None | Significant |
| 24 | Q | 140-160 | 8% | none | Very |
| | | | | | Significant |
| 23B | Q | 140-160 | 5% | 5% B | Very Slight |

What is claimed is:

1. An inkjet ink comprising a pigment dispersion wherein said pigment dispersion comprises a carbon black pigment and an aqueous vehicle, wherein said pigment has an oil absorption of between about 110 to about 50.

2. The ink of claim 1, wherein said oil absorption is between about 95 to about 50.

3. The ink of claim 2, wherein said ink is printed on a low porosity media.

4. The ink of claim 3, wherein said pigment is dispersed by a polymeric dispersant.

5. The ink of claim 4, wherein said polymeric dispersant is a polyurethane.

6. The ink of claim 5, further comprising a polymeric binder.

7. The ink of claim 6, wherein the ratio of said pigment to the total of said polymeric dispersant and said polymeric binder is at least about 7:1.

8. The ink of claim 3, wherein said pigment is a self-dispersing pigment.

9. The ink of claim 8, further comprising a polymeric binder.

10. The ink of claim 9, wherein the ratio of said pigment to said polymeric binder is at least about 7:1.
